(19) United States
(12) Patent Application Publication
(10) Pub. No.: US 2020/0029733 A1
(43) Pub. Date: Jan. 30, 2020

(54) Fire-Starting Device with Slot for Outdoor Grill

(71) Applicant: Hilliard B. Talley, JR., Havelock, NC (US)

(72) Inventor: Hilliard B. Talley, JR., Havelock, NC (US)

(21) Appl. No.: 16/048,236

(22) Filed: Jul. 28, 2018

(51) Int. Cl. A47J 37/07

(52) U.S. Cl. CPC A47J 37/079

(57) ABSTRACT

This document presents a fire starter device having an internal channel as bounded by two flanges mounted in the interior of the fire starter device to optimize the amount of energy provided to charcoal, wood chips, or any other flammable materials placed within the fire starter device from paper or other starter materials. The removable charcoal retention insert permits materials to be introduced into the fire starter device and retained in place until the user has positioned the fire starter device where desired. The shape and removable charcoal retention insert as emplaced within the fire starter device optimize the ignition of the flammable materials placed within the device.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Home grilling enthusiasts, backyard chefs, and other grill professionals use various methods to start a fire in the grill box. A common method is to use lighter fluid to start a pile of briquettes or charcoal, however, this method can impart a bit of a chemical taste sometimes. For this reason, methods of starting charcoal burning without using chemicals such as lighter fluid are preferred.

Another method for starting charcoal utilizes a fire-starting device having a cylindrical tube with a handle into which charcoal or charcoal briquettes may be inserted. The cylindrical tube typically has a non-movable metal grid at the bottom of the tube to prevent the briquettes from falling to the grill surface and providing a space into which paper may be inserted. The paper is placed beneath the charcoal and below the metal grid and ignited. All of the heat from the burning paper is contained within the cylindrical wall of the tube permitting all of the energy to be applied to the charcoal that is in the body of the fire starting device. The concentration of the fire and constraint of all of the energy within the cylindrical body of the fire starter permits charcoal or charcoal briquettes to be ignited more quickly and without the chemical tang of fire starting chemicals.

Once the charcoal has been thoroughly ignited, the user may grab the handle on the outside of the cylindrical body, which has been shielded from the radiated heat from the exterior surface of the device and pour the burning charcoal onto the grill. The blazing charcoal is then ready to use, free from chemical interference, through the use of a fire starting device.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a side view of the exterior of the fire starter device with shovel entry points consistent with certain embodiments of the present invention.

FIG. 2 is a side view of the fire starter device and side ventilation cutouts consistent with certain embodiments of the present invention.

FIG. 3 is a view of the fire starter device and grid insert in close association consistent with certain embodiments of the present invention.

FIG. 4 is a view of the fire starter device and grid insert installed within the flange slot consistent with certain embodiments of the present invention.

FIG. 5 is an interior view of the fire starter device in place on a grill consistent with certain embodiments of the present invention.

FIG. 6 is an inverted view of the fire starter device holding charcoal in place consistent with certain embodiments of the present invention.

FIG. 7 is a top down view of the cross section of the fire starter device holding the shovel insert in place consistent with certain embodiments of the present invention.

FIG. 8 is a top down and side view of the charcoal retention insert to the fire starter device consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Fire starting devices having a cylindrical body provide for some concentration of the energy from a fire started within the base of the cylindrical body. However, having to turn the fire starter device over to dump out the charcoal onto the grill after the charcoal is on fire can be awkward and even result in flaming charcoal coming to rest in locations that are not desirable. A device that may have an insert element to retain and remove the flaming charcoal without having to turn over the device would improve the experience of starting a fire for all grill enthusiasts.

In an embodiment, year-round barbecue enthusiasts can enjoy getting food to the grill more efficiently through the use of an insert that is inserted into the cylindrical body of the fire started through one or more slots that are opened through the sides of the cylindrical body of the fire starter. In a non-limiting example, the insert may be held in place with an interior flange disposed immediately above the slots that form openings in the side of the cylindrical body and an interior flange disposed immediately below said slots. In this non-limiting example, the upper and lower flanges are fastened to the interior surface of the cylindrical body of the fire starter device.

The insert, a charcoal retention insert, may be inserted through one or more slots in the cylindrical body of the fire starter device. The charcoal may be poured into the open top of the fire starter device, just as in conventional use, with the charcoal retention insert placed within the slot to retain the charcoal in place. The flange and charcoal retention insert may also be used with fire starter devices having alternative shapes, such as a pyramidal shape instead of a common cylinder as the body of the fire starter device.

In an embodiment, the fire starter device may also have a ‘safe to hold’ handle shielded behind a secure barrier that forms a heat shield for the user. The secure barrier, or heat shield, is attached to the device where the handle attaches to the side of the fire starter device, occupies a position between the side of the fire starter so as to form a heat barrier between the side of the pyramid fire starter and the handle, yet provide sufficient clearance between the handle and the heat shield to permit a user to grasp the handle without interference by the heat shield. The heat shield may be manufactured of metal or heat resistant material and may be of substantially the same vertical dimension of the exterior wall of the fire starter. Positioned below the handle and the handle shield the slot permitting access for the charcoal retention insert to be placed within the slot and held in place by the flanges fixed above and below the slot on the interior surface of the cylindrical body of the fire starter device. Positioned vertically above the slot into which the charcoal retention insert is positioned are two or more rows of ventilation openings. Positioned vertically below the handle are two or more circular port holes that form drafting openings to provide air circulation to the bottom of the charcoal disposed within the fire starter device. The port holes provided underneath and through the sides of the fire starter unit provide for good air circulation for ‘sure to catch fire’ grilling/entertaining barbecue experiences.

In an embodiment, the insert placed in the fire starter device may also function as a grill shovel to not only permit charcoal retention, but also serve as a device to assist in picking up a grill grate. The insert may have a tapered end portion with one or more low profile flanges to assist in hooking onto the grill grate and permitting the movement of the grill grate without a user touching the grill grate with bare or even gloved hands.

In an embodiment, when getting ready to initially start a fire there are at least three methods for inserting flammable materials and igniting the flammable materials. A user may remove the charcoal retention insert, place the fire starter device directly inside the grill where the user wants the charcoal or other flammable materials to be placed, fill the fire starter device with charcoal and light from the bottom of the fire starter device.

In an alternative embodiment, the user may insert the charcoal retention insert then pour in the charcoal or other flammable material and light from the bottom of the fire starter device. After the flammable material has ignited, the user may remove the charcoal retention insert to permit the lit charcoal or other flammable material to move down to the grill grate. When the charcoal is sufficiently hot and in active combustion, the user may remove the fire starter device and leave the charcoal directly on the grill grate.

In a second alternative embodiment, the user may insert the charcoal retention insert into the fire starter device, where it is held in place by the upper and lower flanges attached to the interior walls of the fire starter device, pour in the charcoal or other flammable material and light from the bottom of the fire starter device. The user may then pour the lit charcoal or other flammable material onto the grill from the top of the unit.

In an embodiment, the fire starter device may be constructed of durable and rust resistant metal to contain proper grilling heat, which is designed to efficiently light charcoal or other flammable materials simply and quickly. A user may also use the fire starter device as a smoker by simply adding soaked wood chips to the grill and placing a cover over the grill and fire starter device.

In an embodiment, the fire starter device has an ergonomic, heat resistant handle. The heat resistant handle permits a user to safely hold the fire starter device with ignited flammable materials with better safety shielding protection. The fire starter device also has a secure in and out charcoal retention insert that serves as a slideable grate. The device may be initially shipped with the charcoal retention insert removed from the body of the fire starter device and shipped as a separate component. The charcoal retention insert may be secured to one of the 2 sides (not the handle side) with tie straps installed during storage. This feature permits the fire starter device to be somewhat stackable for transporting/shelving.

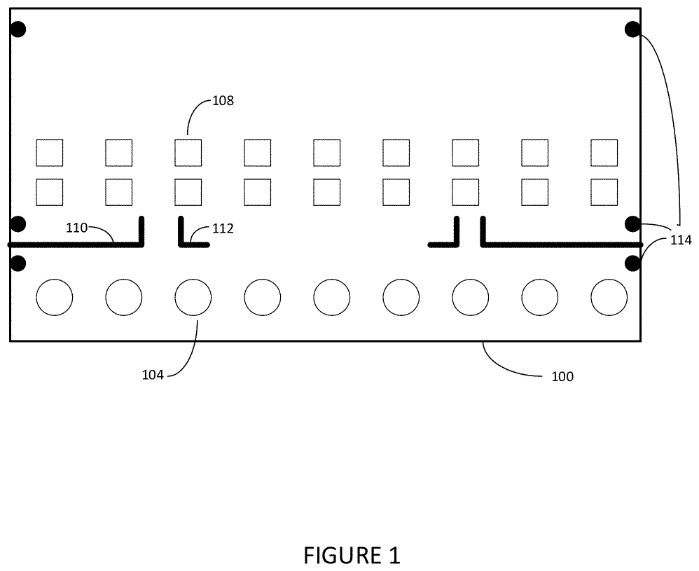

Turning now to FIG. 1, this figure presents a side view of the exterior of the fire starter device prior to forming the completed device consistent with certain embodiments of the present invention. In an exemplary embodiment, the body of the fire starter device 100 may be substantially formed as a cylinder, square, rectangle, pyramid, or other regular shape, with the base of the fire starter device configured to accept charcoal in any form, such as briquettes, chunks, sticks, freeform, or any other form. The base of the fire starter device may have one or more ventilation port holes 104 disposed in a vertical position below the handle at the bottom of the fire starter device and passing through the side of the fire starter device to permit the free flow of air and combustion products such as smoke through the ventilation holes. The fire starter device may also have two or more rows of upper ventilation holes 108 disposed through the side of the fire starter device. The upper ventilation holes 108 contribute to combustion of the charcoal in the base of the fire starter device by permitting the inflow of air across the top of the charcoal disposed within the fire starter device.

The fire starter device may have an insert slot 110 that is configured below and on the same physical side of the fire starter device as the handle. The fire starter device may also have insert slots 112 that provide openings on the opposite side of the fire starter device from the handle to permit the front portion of the charcoal retention insert to extend beyond the side of the fire starter device opposite to the handle when the charcoal retention insert is in the fully inserted position within the fire starter device. Rivets 114 are positioned at the edges of the body of the fire starter device so as to retain the shape of the fire starter device when the rivets are emplaced.

In this embodiment, the fire starter device may have one or more flanges (not shown) installed within the body of the fire starter device by attaching the flange(s) to the interior surface of the body of the fire starter device. The fire starter device may preferably have two flanges, one installed vertically above the second, to form a channel in the interior of the fire starter device. The slot formed by the two flanges support the weight of the charcoal retention insert when inserted within the body of the fire starter device and provides for retention of charcoal in the proper position for lighting when the charcoal retention insert is emplaced within the fire starter device.

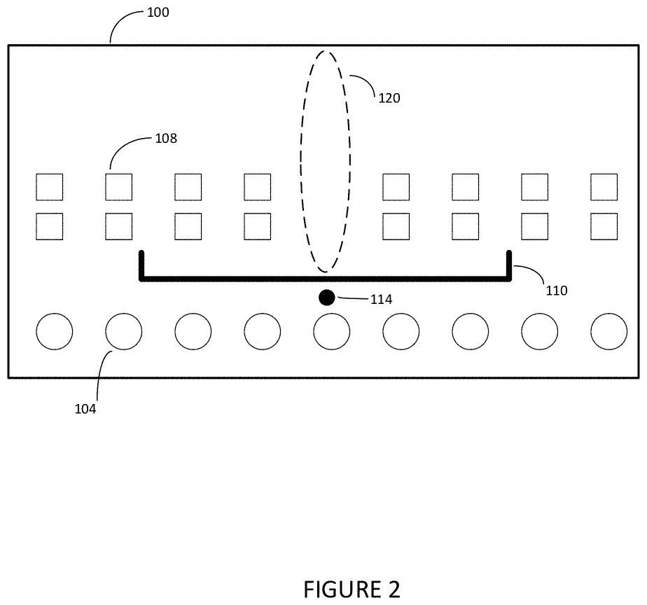

Turning now to FIG. 2, this figure presents a view of the handle connection to the fire starter device consistent with certain embodiments of the present invention. In an exemplary embodiment, the system presents a fire starter device body 100 having lower ventilation port holes 104 and upper ventilation holes 108 disposed through the side of the fire starter device. The fire starter device may be retained in its final shape through the connection of a two or more rivets 114 disposed through the edges of the fire starter device and positioned to secure the edges together. The fire starter device may also have a connection point for an insulated handle 120. The connection point provides a connection of sufficient strength to permit the fire starter device to be lifted by the insulated handle 120 when the fire starter device is empty or loaded with charcoal.

In an embodiment, a charcoal retention insert slot 110 permits a user to insert and remove a charcoal retention insert into and out of the body of the fire starter device. The charcoal retention insert slot 110 is positioned vertically below the insulated handle 120 when the device is positioned in an upright orientation.

Turning now to FIG. 3, this figure presents a view of the fire starter device and grid insert in close association consistent with certain embodiments of the present invention. In an exemplary embodiment, the fire starter device with a slot formed in the side wall of the device below the fire resistant handle is shown with the relative size of the charcoal retention insert next to the handle. The charcoal retention insert may be placed within the fire starter device by inserting the charcoal retention insert into the slot in the side wall of the fire starter device, where the charcoal retention insert is held in place by the internal flanges installed within the interior of the body of the fire starter device.

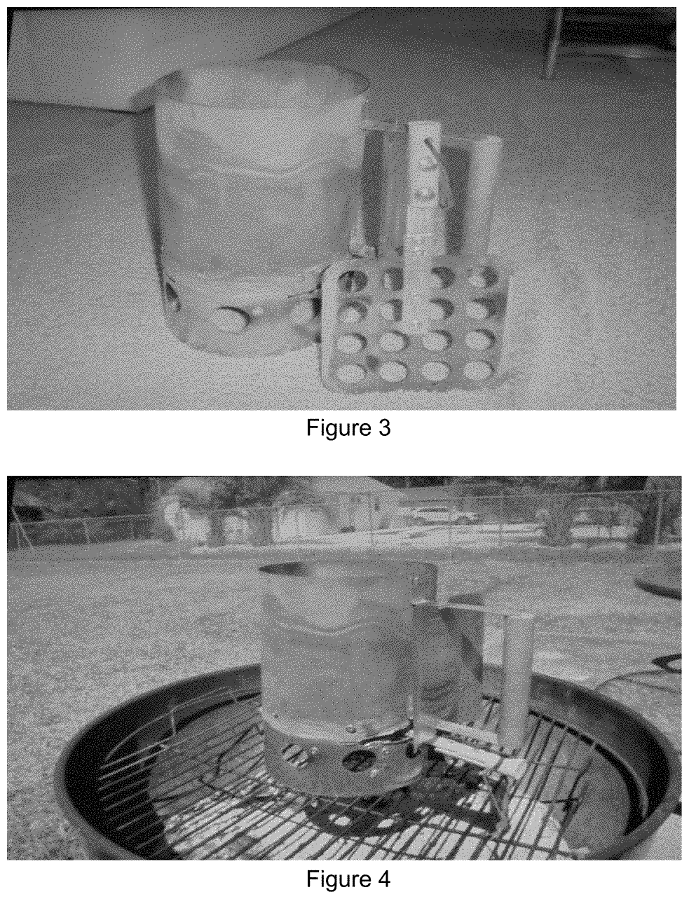

Turning now to FIG. 4, this figure presents a view of the fire starter device and grid insert installed within the flange slot consistent with certain embodiments of the present invention. In an exemplary embodiment, the fire starter device may be placed upon the grill of an outdoor barbeque grill. The charcoal retention insert is shown in place within the body of the fire starter device with the fire resistant handle of the insert extending below the handle of the fire starter device for ease of access. The fire starter device is ready in this configuration to insert charcoal and begin the fire starting process.

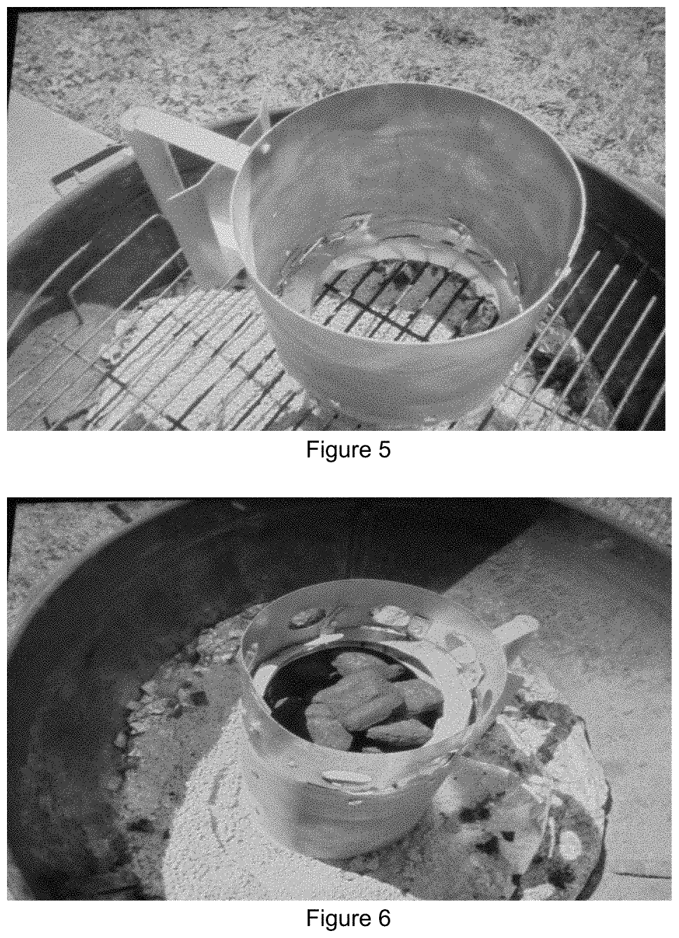

Turning now to FIG. 5, this figure presents an interior view of the fire starter device in place on a grill consistent with certain embodiments of the present invention. In this embodiment, the interior surface of the fire starter device is shown with the internal flanges in a vertical orientation. In this configuration, the fire starter device is prepared for the insertion of the charcoal retention insert. Alternatively, the charcoal retention insert may not be inserted into the flanges and the charcoal instead poured within the fire starter device and in contact directly with the surface of the grill. However, the insertion of the charcoal retention insert between the flanges permits a more efficient use of the fire starter device.

Turning now to FIG. 6, this figure presents an inverted view of the fire starter device holding charcoal in place consistent with certain embodiments of the present invention. In this embodiment, the fire starter device may be used without the charcoal retention insert to permit direct contact between the charcoal and the surface of the grill.

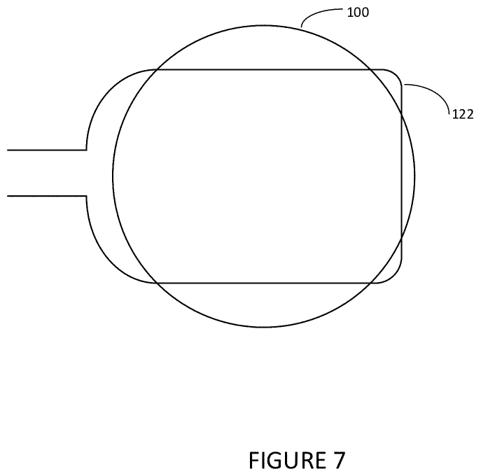

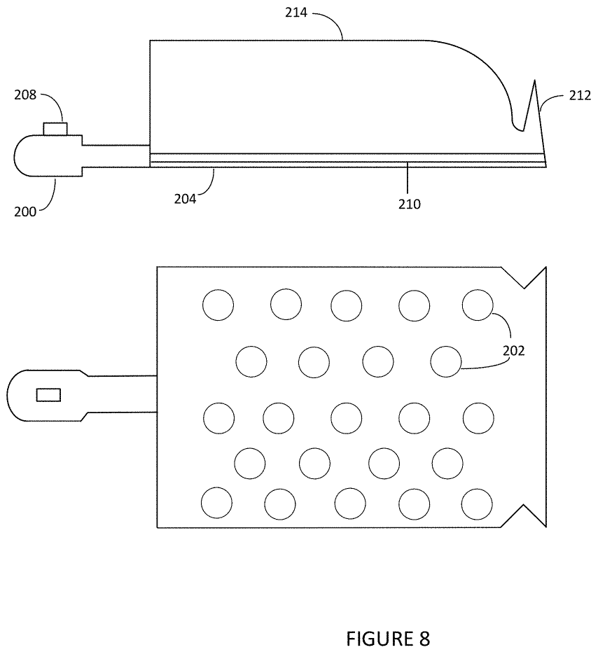

Turning now to FIG. 7, this figure presents an overhead view of the fire starter device with a charcoal retention device inserted in place consistent with certain embodiments of the present invention. In this exemplary embodiment, the fire starter device body 100 is presented with a cylindrical shaped body. The charcoal retention insert 122 may be fully inserted into the charcoal retention insert slot located on the handle side of the fire starter device such that the charcoal retention insert 122 may extend beyond the side of the fire starter device on the opposite side of the fire starter device from the handle side.

Turning now to FIG. 8, this figure presents a top down and side view of the charcoal retention insert to the fire starter device consistent with certain embodiments of the present invention. In an exemplary embodiment, the charcoal retention insert 122 comprises a handle 200 composed of a non-heat conductive material such as wood or plastic, connected to the body of the charcoal retention insert 122. The body of the charcoal retention insert is of sufficient length and width so as to completely cover the interior of the body of the fire starter device when fully inserted into the slot in the side of the fire starter device. The body of the fire starter device may have a grid of openings 202 passing through a first flat surface 204 of the body to permit air to pass through the first flat surface 204 of the body to foster combustion of charcoal resting on the first flat surface 204, and permit ashes to drop down below the flat surface so as to not impede combustion. The body of the charcoal retention insert may also have a second flat panel 210 resting on the upper surface of the body of the charcoal retention insert. The second flat panel 210 may have a grid of openings 202 as well and may be connected to a button 208 on the handle of the charcoal retention insert. The button 208 may be configured to extend and retract the second flat panel 210 portion. The grid of openings 202 in the second flat panel 210 may match the grid of openings 202 in the first flat surface 204 when the second flat panel 210 is a fully retracted position. The grid of openings 202 may be configured to form a mis-match with the grid of opening in the first flat surface 204 when the second flat panel 210 is in a fully extended position to permit a user to close the grid of openings 202 in the first flat surface 204 of the charcoal retention insert 122 to permit the charcoal retention insert 122 to function as a shovel.

The body of the fire starter may also have a hook portion 212 on the distal portion of the body of the charcoal retention insert 122 opposite to the handle portion 200. The hook portion 212 may be configured to assist the user in hooking onto and lifting up a grill grate when the charcoal retention insert 122 is removed from the fire starter device. The body of the charcoal retention insert may also have upright sides 214 configured at a ninety-degree angle from the first flat surface 204 and extending along each side of the first flat surface 204 exclusive of the distal end of the first flat surface 204, which is configured as a hook portion 212. The extension button 208, first flat surface 204, second flat panel 210 and hook portion 212 are present to assist a user in keeping their hands clean when performing fire starter and grilling operations.

While certain illustrative embodiments have been described, it is evident that many alternatives, modifications, permutations and variations will become apparent to those skilled in the art in light of the foregoing description.

I claim:

1. A fire starter device, comprising:
a body having a central cavity and an open top and open bottom;
said body having two or more rows of ventilation openings passing through the sides of said body;
said body having one or more slots extending through the sides of said body;
a handle affixed to the exterior surface of said body; and
a charcoal retention insert of sufficient size to be slideably inserted into at least one of said one or more slots where the charcoal retention insert provides a platform onto which charcoal rests during a lighting action.

2. The fire starter device of claim 1, further comprising a shield affixed to said handle and disposed between said handle and a side of the fire starter device.

3. The fire starter device of claim 1, where at least one row of ventilation openings is positioned below said one or more slots when the fire starter device is positioned in a vertically upright orientation.

4. The fire starter device of claim 1, where two or more rows of ventilation openings are positioned above said one or more slots when the fire starter device is positioned in a vertically upright orientation.

5. The fire starter device of claim 1, where one or more slots are disposed on the same side of the fire starter device as said handle, and one or more slots are disposed on the opposite side of the fire starter device from said handle.

6. The fire starter device of claim 1, further comprising a upper flange affixed to the interior of said body above said one or more slots, and a lower flange affixed to the interior of said body below said one or more slots, where the upper flange and the lower flange form a bracket for support of said charcoal retention insert.

7. The fire starter device of claim 6, where said upper flange and said lower flange extend around the entire interior circumference of said body.
